(19) United States
(12) Patent Application Publication
(10) Pub. No.: US 2026/0208493 A1
(43) Pub. Date: Jul. 23, 2026

(54) INK STORAGE CONTAINER AND RECORDING APPARATUS

(71) Applicant: CANON KABUSHIKI KAISHA, Tokyo (JP)

(72) Inventors: MAKOTO WATANABE, Kanagawa (JP); AKIHIRO TAKEDA, Tokyo (JP); TAKANOBU MANABE, Kanagawa (JP); JUNICHIRO IRI, Kanagawa (JP)

(21) Appl. No.: 19/442,862

(22) Filed: Jan. 7, 2026

(30) Foreign Application Priority Data
Jan. 20, 2025 (JP) 2025-007750

(51) Int. Cl. B41J 2/175

(52) U.S. Cl. CPC B41J 2/17523; B41J 2/17513; B41J 2/17553; B41J 2002/17516

(57) ABSTRACT

An ink storage container includes an ink storage portion configured to have flexibility and to store ink therein, and an ink supply portion provided at one end of the ink storage portion and configured to supply ink stored in the ink storage portion to an outside, wherein the ink supply portion includes a flow path extending in an extending direction from the one end toward an interior of the ink storage portion, and wherein during a decrease in an amount of ink stored in the ink storage portion, a cross-sectional area of the flow path in a plane perpendicular to the extending direction decreases.

### BACKGROUND

### Field of the Technology

The present disclosure relates to an ink storage container and a recording apparatus including the ink storage container.

### Description of the Related Art

Conventionally, a recording apparatus is provided with a recording head, a unit for driving a carriage on which the recording head is mounted, a unit for conveying a recording medium, and a control unit for controlling these components. Typically, inkjet printers are known as such a recording apparatus. As a configuration for supplying liquid (for example, ink) to a recording apparatus, in order to facilitate replenishment of ink in accordance with ink consumption resulting from recording, there is a configuration in which an ink tank serving as an ink supply source is designed to be attachable to and detachable from a main body of the recording apparatus, which allows the ink tank to be manually replaced by a user and used. Regarding such an ink storage container, an ink storage container having an increased capacity to reduce replacement frequency, and further, configured as a bag formed of a flexible film, such as aluminum laminate, for storing a liquid to facilitate handling is known.

Japanese Patent Application Laid-Open No. 2018-065373 describes a configuration in which an ink outlet member is attached to one end of a bag serving as an ink storage container, and an ink outlet tube is connected to an end of a spacer member extending toward the other end of the bag. Through an outlet of the ink outlet tube disposed at the center portion inside the bag, ink is guided from a deep region inside the bag to the ink outlet member. According to Japanese Patent Application Laid-Open No. 2018-065373, since the ink outlet tube is disposed inside an ink storage portion provided in the bag, a flow path for ink is secured around the ink outlet tube, whereby blockage of the flow path inside the bag is less likely to occur. In addition, the spacer member prevents blockage of the flow path even at the deep portion of the bag, whereby the possibility that ink cannot be sufficiently supplied to a recording apparatus as the bag contracts can be reduced.

From the viewpoint of environmental consideration, it is desirable to reduce plastic parts used in the ink storage container and also to improve ink usage efficiency. Japanese Patent Application Laid-Open No. 2018-065373 describes that the ink outlet member is attached and that the ink outlet tube and the spacer member are made of plastic. When the ink stored in the ink storage portion is consumed, and the ink storage portion is collapsed, an ink inlet member, which is a plastic member, does not collapse, so that blockage of the flow path is less likely to occur. However, a level difference occurs between the ink inlet member and the collapsed ink storage portion, and as a result, a space is formed. When the periphery of the space is blocked, ink remains partially in the space, and the ink usage efficiency decreases. Furthermore, in manufacturing of the ink storage container, when the interior of the ink storage container is degassed prior to ink filling, the ink outlet tube and the spacer member disposed inside the ink storage container do not collapse, which results in residual air inside the ink storage container, and the residual air affects a dissolved oxygen concentration of ink to be stored.

### SUMMARY

The present disclosure is directed to providing an ink storage container with improved ink usage efficiency and a recording apparatus including the ink storage container.

According to some embodiments of the present disclosure, an ink storage container includes an ink storage portion configured to have flexibility and to store ink therein, and an ink supply portion provided at one end of the ink storage portion and configured to supply ink stored in the ink storage portion to an outside, wherein the ink supply portion includes a flow path extending in an extending direction from the one end toward an interior of the ink storage portion, and wherein during a decrease in an amount of ink stored in the ink storage portion, a cross-sectional area of the flow path in a plane perpendicular to the extending direction decreases.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an internal configuration of a main part of a recording apparatus according to a first embodiment.

FIG. 2 is a diagram illustrating a configuration of a liquid supply unit tray illustrated in FIG. 1.

FIG. 3 is a diagram illustrating a configuration of an ink storage container according to the first embodiment.

FIG. 4 is a cross-sectional view taken along line A-A′ of the ink storage container according to the first embodiment.

FIGS. 5A and 5B are perspective views each illustrating a flow path according to the first embodiment.

FIG. 6 is a diagram illustrating a configuration of an ink storage container according to a second embodiment.

FIG. 7 is a cross-sectional view taken along line B-B′ of the ink storage container according to the second embodiment.

FIGS. 8A and 8B are perspective views each illustrating a flow path according to the second embodiment.

FIG. 9 is a diagram illustrating a configuration of an ink storage container according to a third embodiment.

FIG. 10 is a cross-sectional view taken along line C-C′ of the ink storage container according to the third embodiment.

FIG. 11 is a perspective view of a flow path according to the third embodiment.

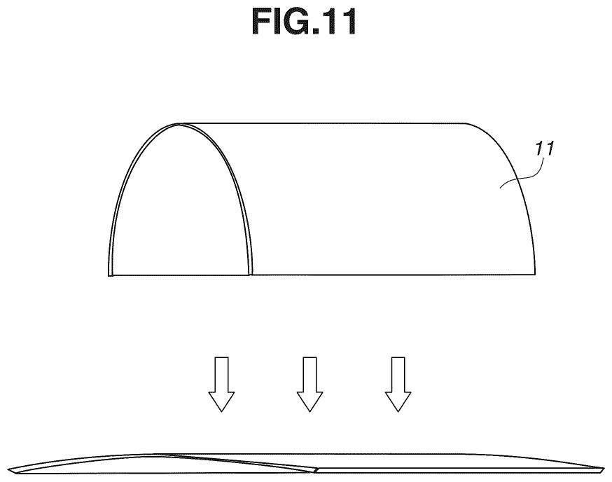

FIG. 12 is a diagram illustrating a configuration of an ink storage container according to a fourth embodiment.

FIG. 13 is a cross-sectional view taken along line D-D′ of the ink storage container according to the fourth embodiment.

FIG. 14 is a perspective view of a flow path according to the fourth embodiment.

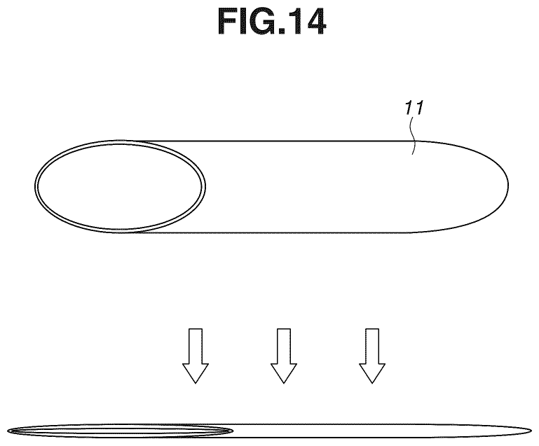

FIG. 15 is a diagram illustrating a configuration of an ink storage container according to a fifth embodiment.

FIG. 16 is a cross-sectional view taken along line E-E′ of the ink storage container according to the fifth embodiment.

FIG. 17 is a diagram illustrating a configuration of an ink storage container according to a sixth embodiment.

FIG. 18 is a cross-sectional view taken along line F-F′ of the ink storage container according to the sixth embodiment.

### DESCRIPTION OF THE EMBODIMENTS

Hereinafter, embodiments of an ink storage container (ink pack, ink cartridge) and a recording apparatus according to the present disclosure will be specifically described with reference to the drawings. The following embodiments are merely exemplary for implementing the present disclosure, and the present disclosure is not limited to these configurations. In addition, the features described in the respective embodiments may be combined in part.

### Recording Apparatus

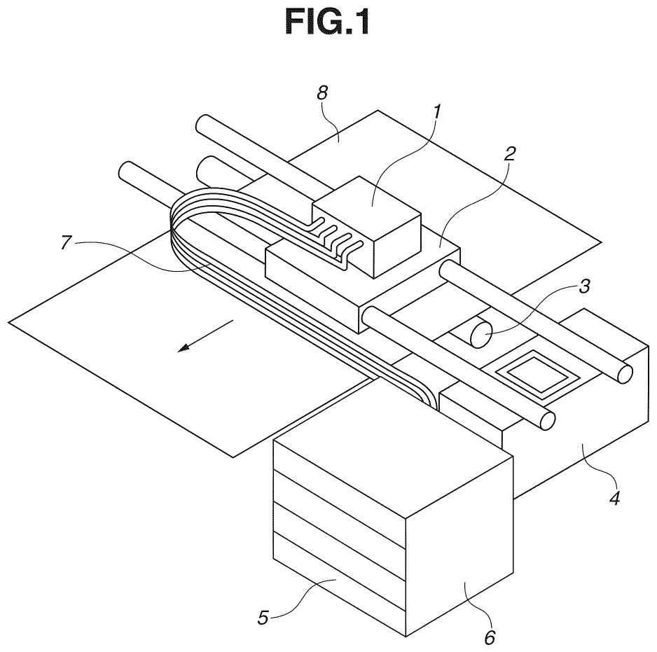

A recording apparatus illustrated in FIG. 1 repeats reciprocating movement (main scanning) of a recording head 1 and conveyance (sub-scanning) of a recording sheet 8 serving as a recording medium at a predetermined pitch. While these movements are synchronized, the recording apparatus selectively ejects a plurality of colored liquids from the recording head 1 and causes the plurality of colored liquids to land on the recording sheet 8 serving as the recording medium, whereby characters, symbols, images, and the like are formed. Any material may be used as long as the material is capable of receiving ink droplets and forming an image. Examples that can be used as the recording medium include various materials and forms, such as paper, cloth, optical disc label surfaces, plastic sheets, overhead projector (OHP) sheets, and envelopes.

In FIG. 1, the recording head 1 is detachably mounted on a carriage 2, which is slidably supported by two guide rails and is reciprocally moved in a straight line along the guide rails by a driving unit, such as a motor (not illustrated). The recording sheet 8, which receives liquid ejected from a liquid ejection portion of the recording head 1, is conveyed by a conveyance roller 3 serving as a conveyance unit in a direction intersecting a moving direction of the carriage 2 while facing a liquid ejection surface of the recording head 1. The recording head 1 includes, as a plurality of liquid ejection portions, a plurality of nozzle arrays for ejecting liquids of different colors. In correspondence with the colors of the liquids to be ejected from the recording head 1, a plurality of liquid supply unit trays 5, each being independent from the others and having a liquid supply port, is detachably mounted on a liquid supply unit 6. The liquid supply unit 6 and the recording head 1 are connected to each other by a plurality of liquid supply tubes 7 each corresponding to a different color of the colored liquids. By housing an ink storage container 10 in the liquid supply unit tray 5 and mounting a plurality of the liquid supply unit trays 5 on the liquid supply unit 6, it becomes possible to independently supply each colored liquid stored in a different liquid supply unit tray of the liquid supply unit trays 5 to the corresponding nozzle array of the recording head 1. In a non-recording region within a range of the reciprocating movement of the recording head 1 and outside a passage range of the recording sheet 8, a recovery unit 4 is disposed in such a manner that the recovery unit 4 faces the liquid ejection surface of the recording head 1. The recovery unit 4 includes a cap portion for capping the liquid ejection surface of the recording head 1, a suction mechanism for forcibly sucking liquid in a state where the liquid ejection surface is capped, and a cleaning blade for wiping off contamination on the liquid ejection surface. The above-described suction operation is performed by the recovery unit 4 prior to a recording operation of the recording apparatus. Thus, even when the recording apparatus is operated after being left unused for a long period of time, the recovery unit 4 performs recovery processing to remove residual bubbles in the liquid ejection portion of the recording head 1 and thickened liquid in a vicinity of an ejection port, whereby ejection characteristics of the recording head 1 are maintained.

### Ink Storage Container

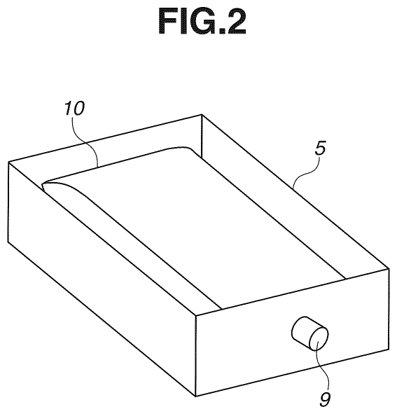

FIG. 2 is a schematic perspective view illustrating the inside of the liquid supply unit tray 5 for each color installed in the liquid supply unit 6 of the recording apparatus illustrated in FIG. 1. An ink storage container 10 is disposed inside the liquid supply unit tray 5.

In the present disclosure, the ink storage container 10 includes an ink storage portion configured to store ink therein and an ink supply portion. The ink storage portion has flexibility. The ink supply portion is provided at one end of the ink storage portion and is configured to supply ink stored in the ink storage portion to the outside. The ink supply portion includes a flow path extending from one end of the ink storage portion toward the interior of the ink storage portion. In the present disclosure, a direction in which the flow path extends is referred to as an extending direction. In a usage state in which the ink storage container is mounted in a main body of the recording apparatus, a direction of gravity and the above-described extending direction are orthogonal to each other. The extending direction is a direction parallel to a horizontal plane of the ink storage portion, which has been substantially flattened after the ink inside the ink storage portion has been consumed.

### First and Second Embodiments

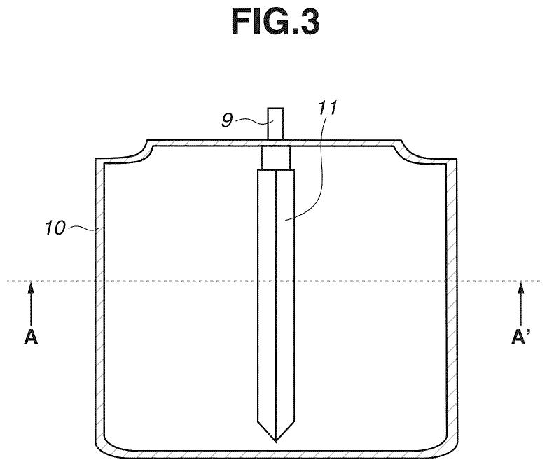

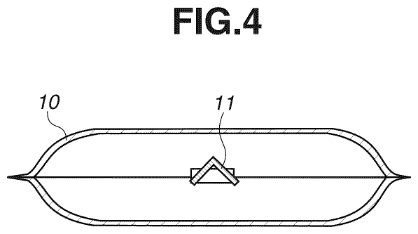

FIG. 3 is a diagram illustrating a configuration of the ink storage container 10 according to a first embodiment, and FIG. 4 is a cross-sectional view taken along line A-A′ of the ink storage container 10 illustrated in FIG. 3.

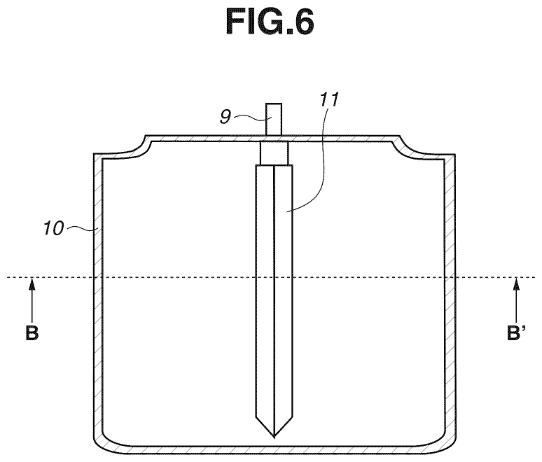

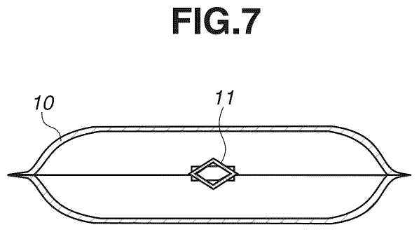

FIG. 6 is a diagram illustrating a configuration of the ink storage container 10 according to a second embodiment, and FIG. 7 is a cross-sectional view taken along line B-B′ of the ink storage container 10 illustrated in FIG. 6.

The ink storage container 10 in the present embodiments has a rectangular shape but may have a different quadrilateral shape, such as a trapezoidal shape or a square shape, or may have a polygonal shape, such as a triangular or pentagonal shape. The ink storage container 10 may also have a shape with rounded corners.

Further, as for a method of manufacturing the ink storage container 10 having such a shape, a known method may be used. Specifically, the ink storage container 10 may be a pillow type formed by stacking two films and joining peripheral portions of the films together, or a gusset type.

In the present disclosure, the ink storage container 10 has flexibility. The expression “having flexibility” as used in the present disclosure means that the ink storage container 10 is pliant and can be bent.

As a material for the ink storage container 10, any known material may be used as long as the ink storage container 10 is capable of storing ink therein and has flexibility. Specifically, examples include resin films, such as polyethylene terephthalate (PET), polyamide (PA), polyethylene (PE), and polypropylene (PP). A film having a layered structure formed by layering a plurality of the resin films may also be used. Alternatively, a coated film or a vapor-deposited film in which gas barrier properties or moisture barrier properties have been imparted to the resin films may be used. Furthermore, a film formed by layering paper or aluminum foil on a resin film may also be used. From the viewpoint of storing ink, a material capable of suppressing evaporation of moisture in the ink is desirable. In particular, it is desirable to use aluminum foil. The film thickness of a film for the ink storage portion is desirably 100 micrometers (μm) or more and 220 μm or less.

In the present embodiments, a flow path 11 is extended to a vicinity of an end portion of the ink storage container 10, and the cross section in a plane perpendicular to the extending direction has a V-shape or a rhombus shape. If a liquid outlet tube or a spacer member as described in Japanese Patent Application Laid-Open No. 2018-065373 is absent, when ink stored in the ink storage container 10 is consumed, the ink storage container 10 collapses, and consequently, a path for the ink to flow toward the ink supply portion may be blocked. As a result, there arises an issue that the ink usage efficiency decreases.

To address this issue, the flow path 11 is extended to the vicinity of the end portion of the ink storage container 10, so that an occurrence of the blockage is suppressed, and the ink stored in the ink storage portion can be completely consumed. In order to realize the configuration, it is desirable that an end portion of the flow path 11 extending from an ink supply tube 9 be disposed at a distance of 3.0 millimeters (mm) or more and 5.0 mm or less from the end portion of the ink storage container 10 in which the ink is stored.

This configuration is for the issue that ink remains at the end portion of the ink storage container 10 due to the blockage.

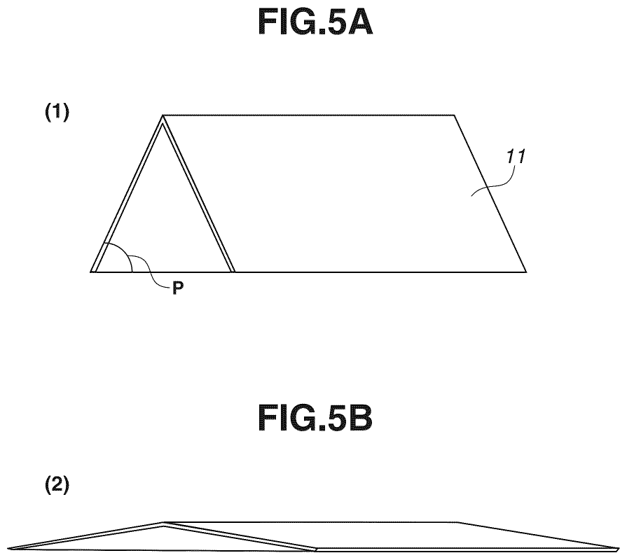

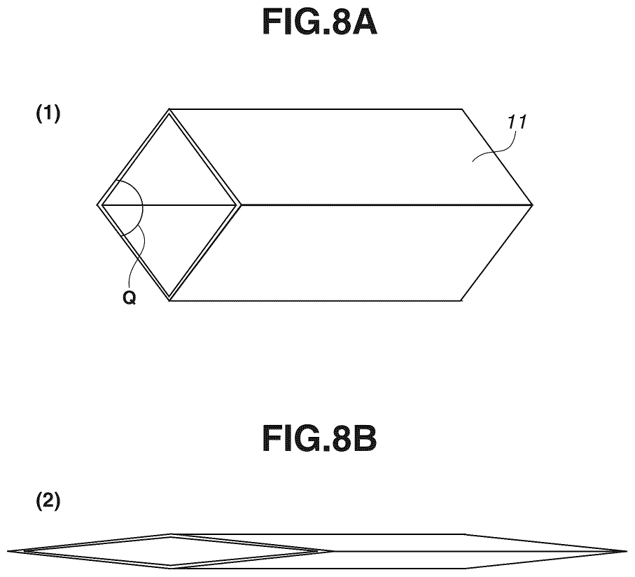

FIGS. 5A and 5B are perspective views each illustrating the flow path 11 according to the first embodiment, and FIGS. 8A and 8B are perspective views each illustrating the flow path 11 according to the second embodiment. FIGS. 5A and 8A illustrate a state (1) during ink consumption, and FIGS. 5B and 8B illustrate a state (2) in which the ink is nearly consumed. The flow path 11 may have rigidity sufficient to support a downward force exerted by an upper surface of the ink storage container 10 as the ink is consumed and the ink storage container 10 collapses. This secures a space serving as a path through which ink can pass, inside the ink storage container 10. On the other hand, when all the ink inside the ink storage container 10 is nearly consumed, the flow path 11 can no longer resist the downward force exerted by the upper surface of the ink storage container 10, and the flow path 11 deforms in such a manner that an area of the cross section (cross-sectional area) of the flow path 11 decreases. Finally, when all the ink is consumed, the flow path 11 collapses into a flattened state together with the upper surface and a lower surface of the ink storage container 10, whereby the ink usage efficiency can be ensured. That is, as the amount of ink stored in the ink storage portion decreases, the cross-sectional area of the flow path 11 in a plane perpendicular to the extending direction is reduced.

As described above, since the structure may have a certain rigidity against pressure in a direction in which the ink storage container 10 collapses (in a vertical direction in a stationary state of the ink storage container 10), and to collapse into a flattened state ultimately, it is desirable that the cross-sectional shape of the flow path 11 be a V-shape or a rhombus shape. If the shape is, for example, a triangular shape, a space serving as a path for ink during ink consumption can be secured, but when all the ink is consumed, the flow path 11 does not easily collapse into a flattened state, and thus, there is a possibility that residual ink remains in the ink storage container 10.

Regarding a detailed shape, the V-shape may be divided into two right triangles, and the rhombus shape may be divided into four right triangles, and the description is provided with reference to one right triangle. As for an angle of the right triangle, it is desirable that the inclination angle be 30 degrees (°) or less. Further, the film thickness of the flow path 11 is desirably 0.9 mm or more and 1.1 mm or less.

That is, in a case where the flow path 11 has a V-shape, it is desirable that an internal angle (angle P illustrated in FIG. 5A) formed between the lower surface of the ink storage container 10 and the V-shape in the cross section be 30° or less.

Alternatively, in a case where the flow path 11 has a rhombus shape, it is desirable that an internal angle (angle Q illustrated in FIG. 8A) of the rhombus shape in the cross section be 60° or less.

In the case of the V-shape, a height of the V-shape is set to be equal to or greater than a height of the ink supply tube 9, and a dimension of an inclined surface of the V-shape is determined by sin 60°=height/length of inclined surface, and a dimension of a bottom surface of the V-shape is determined by tan 30°=height/length of bottom surface. In the case of the rhombus shape, a height of the rhombus shape is set to be equal to or greater than half the height of the ink supply tube 9, and a dimension of the inclined surface of the rhombus shape is determined by sin 60°=(height/2)/length of inclined surface, and a dimension of a bottom surface of the rhombus shape is determined by tan 30°=(height/2)/length of bottom surface.

As a material of the flow path 11, it is desirable to use a material having elasticity, such as rubber or elastomer.

### Third and Fourth Embodiments

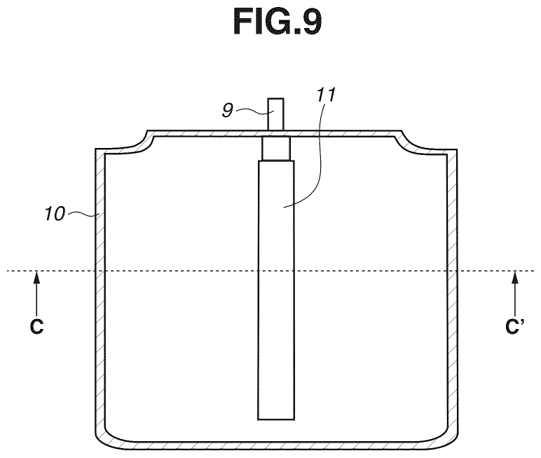

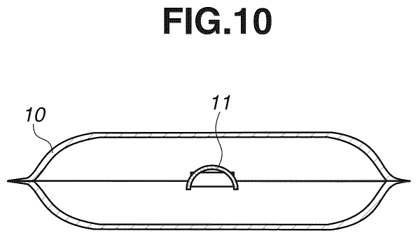

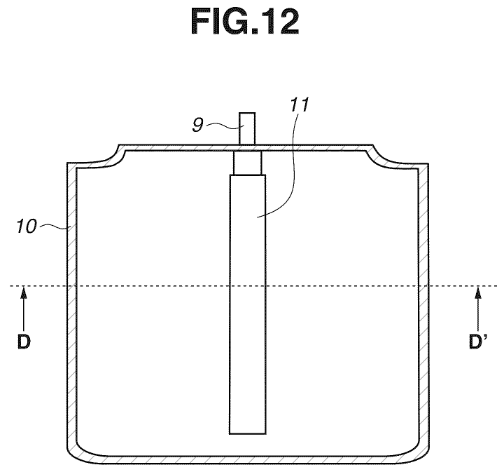

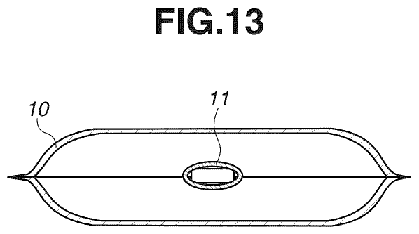

Examples of a desirable cross-sectional shape of the flow path 11 further include a sector shape and an elliptical shape. FIG. 9 is a plan view illustrating a configuration of an ink storage container 10 having a flow path 11 in a sector shape according to a third embodiment, and FIG. 10 is a cross-sectional view taken along line C-C′ of the ink storage container 10 illustrated in FIG. 9. In addition, FIG. 12 is a plan view illustrating a configuration of an ink storage container 10 having a flow path 11 in an elliptical shape according to a fourth embodiment, and FIG. 13 is a cross-sectional view taken along line D-D′ of the ink storage container 10 illustrated in FIG. 12.

In a case where a sector shape or an elliptical shape is selected as the cross-sectional shape of the flow path 11, unlike the V-shape or the rhombus shape in the first embodiment and the second embodiment, respectively, there is a concern that, due to the absence of corners in the shape, the flow path 11 may be less likely to collapse into a flattened state together with the ink storage container 10 in which the ink is nearly consumed. To address this concern, in the case of the flow path 11 in a sector shape or an elliptical shape, the film thickness may be thinner in comparison with the film thickness of a case of the flow path 11 in a V-shape or a rhombus shape, and it is desirable that the thickness be 0.5 mm or more and 0.7 mm or less.

As for the detailed shapes, in the case of a sector shape, it is desirable that a radius (height of the flow path 11) be greater than or equal to a height of an ink supply tube 9, and that the central angle of the sector be 160° or more and 180° or less, in order to secure a path for ink. In the case of an elliptical shape, it is desirable that the minor axis be equal to or greater than the height of an ink supply tube 9, and that the ratio of the major axis to the minor axis is 1.2:1 or more and 2:1 or less, with the ellipticity of 0.16 or more and 0.5 or less.

The cross-sectional shape of the flow path 11 is not limited to the shapes described in the first to fourth embodiments, as long as a path for ink can be secured during ink consumption and the flow path 11 can collapse into a flattened state together with the ink storage container 10 when the ink is nearly consumed.

With the flow path 11, it is possible to reduce the amount of plastic parts included in the ink storage container 10 and to improve the ink usage efficiency by suppressing the blockage of a path for ink inside the ink storage container 10. Furthermore, in manufacturing of the ink storage container 10, when the interior of the ink storage container 10 is degassed prior to ink filling, the flow path 11 disposed inside the ink storage container 10 ultimately collapses into a flattened state, which reduces the residual air inside the ink storage container 10, whereby the dissolved oxygen concentration of the ink to be stored can be reduced.

### Fifth and Sixth Embodiments

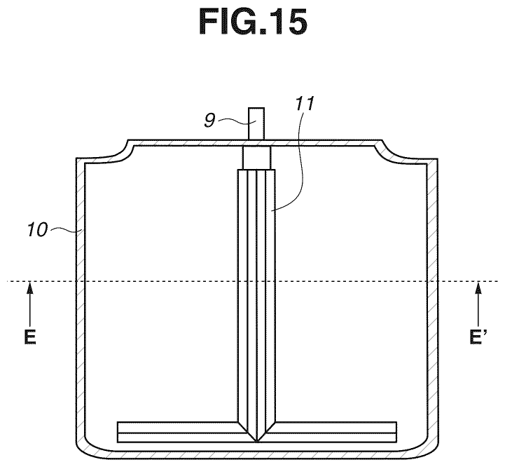

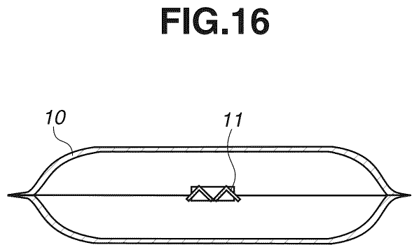

Next, the shape of the flow path 11 in the extending direction will be described. FIG. 15 is a diagram of an ink storage container 10 according to a fifth embodiment, which has a flow path 11 having a cross-sectional area equivalent to a cross-sectional area of the flow path 11 in the first embodiment but with a different shape in the extending direction, and FIG. 16 is a cross-sectional view taken along line E-E′ of the ink storage container 10 illustrated in FIG. 15.

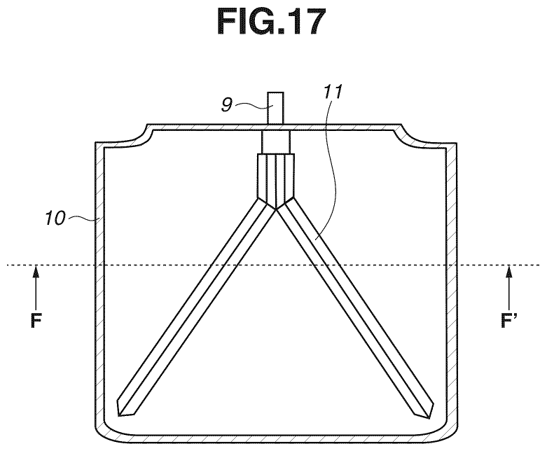

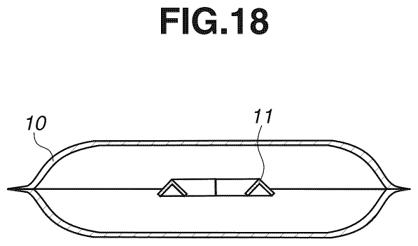

FIG. 17 is a diagram of an ink storage container 10 according to a sixth embodiment, which has a flow path 11 having a cross-sectional area equivalent to the cross-sectional area of the flow path 11 of the first embodiment but with a different shape in the extending direction, and FIG. 18 is a cross-sectional view taken along line F-F′ of the ink storage container 10 illustrated in FIG. 17.

As described above, as ink is consumed, the blockage may occur in the ink storage container 10, resulting in a decrease in the ink usage efficiency. Since a portion where ink remains due to the blockage is an end portion of the ink storage container 10, similar to the first embodiment, it is desirable that an end portion of the flow path 11 extending from an ink supply tube 9 be disposed at a distance of 3.0 mm or more and 5.0 mm or less from the end portion of the ink storage container 10 in which the ink is stored.

Therefore, in the embodiment of FIG. 15, the flow path 11 extending from the ink supply tube 9 is disposed in an inverted T-shape toward corners of the ink storage container 10.

As a different layout in which the flow path 11 is extended toward the corners of the ink storage container 10 as in the embodiment illustrated in FIG. 15, the flow path 11 may be disposed in an inverted Y-shape as illustrated in FIG. 17. It is desirable that an angle of the inverted Y-shape can be changed depending on the size of the ink storage container 10. By providing the ends of the flow path 11 at the corners of the ink storage container 10 as illustrated in FIGS. 15 and 16, it becomes possible to easily draw out not only the remaining ink at a bottom end portion but also the remaining ink at both side end portions of the ink storage container 10.

As described above, even with a simple configuration in which the amount of plastic used as the material for the flow path is reduced in comparison to conventional configurations, the present disclosure can improve the ink usage efficiency. Therefore, the technique described in the present specification can contribute to realization of a sustainable society including deoxygenation and a circular economy.

The disclosure of the present embodiment includes the following configurations.

### Configuration 1

An ink storage container comprising:
an ink storage portion configured to have flexibility and to store ink therein; and
an ink supply portion provided at one end of the ink storage portion and configured to supply ink stored in the ink storage portion to an outside,
wherein the ink supply portion includes a flow path extending in an extending direction from the one end toward an interior of the ink storage portion, and
wherein in a state in which the ink storage portion stores ink therein, a cross-section of the flow path in a plane perpendicular to the extending direction has any one of a V-shape, a rhombus shape, a sector shape, and an elliptical shape.

### Configuration 2

The ink storage container according to Configuration 1, wherein the flow path has elasticity.

### Configuration 3

An ink storage container comprising:
an ink storage portion configured to have flexibility and to store ink therein; and
an ink supply portion provided at one end of the ink storage portion and configured to supply ink stored in the ink storage portion to an outside,
wherein the ink supply portion includes a flow path extending in an extending direction from the one end toward an interior of the ink storage portion, and
wherein during a decrease in an amount of ink stored in the ink storage portion, a cross-sectional area of the flow path in a plane perpendicular to the extending direction decreases.

### Configuration 4

The ink storage container according to Configuration 1, wherein the flow path has elasticity.

### Configuration 5

A recording apparatus comprising:
an apparatus main body; and
an ink storage container configured to be detachably attached to the apparatus main body,
wherein the ink storage container is the ink storage container according to any one of Configurations 1 to 4.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-007750, filed Jan. 20, 2025, which is hereby incorporated by reference herein in its entirety.

What is claimed is:

1. An ink storage container comprising:
an ink storage portion configured to have flexibility and to store ink therein; and
an ink supply portion provided at one end of the ink storage portion and configured to supply ink stored in the ink storage portion to an outside,
wherein the ink supply portion includes a flow path extending in an extending direction from the one end toward an interior of the ink storage portion, and
wherein during a decrease in an amount of ink stored in the ink storage portion, a cross-sectional area of the flow path in a plane perpendicular to the extending direction decreases.

2. The ink storage container according to claim 1, wherein the flow path has elasticity.

3. An ink storage container comprising:
an ink storage portion configured to have flexibility and to store ink therein; and
an ink supply portion provided at one end of the ink storage portion and configured to supply ink stored in the ink storage portion to an outside,
wherein the ink supply portion includes a flow path that extends in an extending direction from the one end toward an interior of the ink storage portion and has flexibility, and
wherein in a state in which the ink storage portion stores ink therein, a cross-section of the flow path in a plane perpendicular to the extending direction has any one of a V-shape, a rhombus shape, a sector shape, and an elliptical shape.

4. A recording apparatus comprising:
an apparatus main body; and
an ink storage container configured to be detachably attached to the apparatus main body,
wherein the ink storage container includes
an ink storage portion configured to have flexibility and to store ink therein, and
an ink supply portion provided at one end of the ink storage portion and configured to supply ink stored in the ink storage portion to an outside,
wherein the ink supply portion includes a flow path extending in an extending direction from the one end toward an interior of the ink storage portion, and
wherein during a decrease in an amount of ink stored in the ink storage portion, a cross-sectional area of the flow path in a plane perpendicular to the extending direction decreases.
